(19) United States
(12) Patent Application Publication
(10) Pub. No.: US 2011/0001710 A1
(43) Pub. Date: Jan. 6, 2011

(54) PORTABLE ELECTRONIC DEVICE WITH MULTIPLE TOUCH PANELS

(75) Inventor: XIAO-DONG WANG, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/636,872

(22) Filed: Dec. 14, 2009

(30) Foreign Application Priority Data
Jul. 3, 2009 (CN) 200910303999.6

(51) Int. Cl. G06F 3/041

(52) U.S. Cl. 345/173

(57) ABSTRACT

An exemplary portable electronic device with multiple touch panels includes a side touch unit and main touch unit, a detection unit, and processor. The main touch unit is electrically connected to the side touch unit, and the detection unit is electrically connected to the side touch unit and the main touch unit. The processor is electrically connected to the detection unit and generates a corresponding control signal to achieve different operations when the side touch unit and the main touch unit are operated.

### BACKGROUND

1. Technical Field

The disclosure generally relates to portable electronic devices, and more particularly to a portable electronic device with multiple touch panels.

2. Description of the Related Art

Portable electronic devices, such as mobile telephones and personal digital assistants (PDAs), feature increasing functionality. Accordingly, various secondary buttons, such as volume button, scroll button, camera button and others, are provided to implement various secondary controls, such as adjusting volume, browsing web pages, operating the camera, and others.

However, despite the physical keys being small, they still increase the size and weight of the portable electronic devices, which impairs development trends toward compact and light structure. One answer to this has been development of touch screens to provide control of the portable electronic devices. However, the secondary controls remain controlled by physical keys, failing to allow reductions in size and profile of the portable electronic devices.

Therefore, there is room for improvement within the art.

### BRIEF DESCRIPTION OF THE DRAWINGS

Many aspects of a portable electronic device with multiple touch panels can be better understood with reference to the following drawings. The components in the drawings are not necessarily drawn to scale, the emphasis instead being placed upon clearly illustrating the principles of the exemplary portable electronic device with multiple touch panels. Moreover, in the drawings, like reference numerals designate corresponding parts throughout the several views. Wherever possible, the same reference numbers are used throughout the drawings to refer to the same or like elements of an embodiment.

FIG. 1 is a block diagram of a portable electronic device with multiple touch panels, according to an exemplary embodiment.

FIG. 2 is a front view of the portable electronic device with multiple touch panels of FIG. 1.

FIG. 3 is a schematic exploded view of a side touch unit of the portable electronic device with multiple touch panels of FIG. 1.

FIG. 4 is an assembled cross-section of the side touch unit of the portable electronic device with multiple touch panels shown in FIG. 3.

### DETAILED DESCRIPTION OF THE EMBODIMENTS

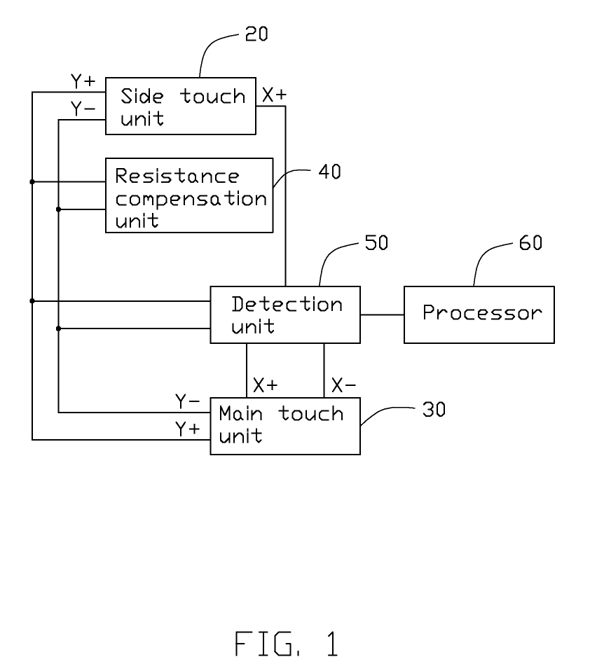

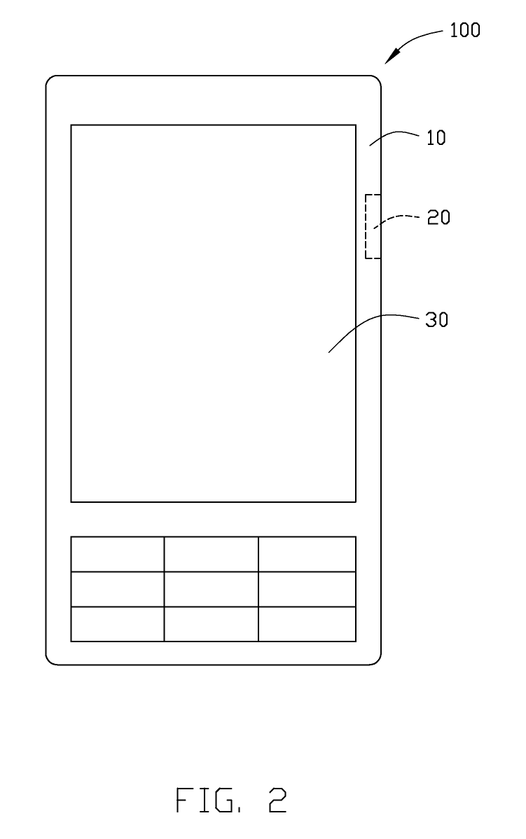

FIGS. 1-2 show an exemplary embodiment of a portable electronic device with multiple touch panels 100 having dual-touch keypad, such as a mobile phone, a PDA. The mobile phone is taken here as an exemplary application.

The portable electronic device with multiple touch panels 100 includes a housing 10, a side touch unit 20, a main touch unit 30, a resistance compensation unit 40, a detection unit 50, and a processor 60. The side touch unit 20 and the main touch unit 30 are disposed on the exterior of the housing 10, and the resistance compensation unit 40, the detection unit 50 and the processor 60 are disposed inside the housing 10.

The side touch unit 20 can be disposed anywhere on the outer periphery of the housing 10, accessible for operation, and can be combined with an existing resistive touch panel. A 4-wire resistive touch panel is taken here as an exemplary embodiment. The side touch unit 20 is configured for replacing controls for volume, camera, scrolling and other physical operation controls, such that the same information and operating instructions can be input thereby.

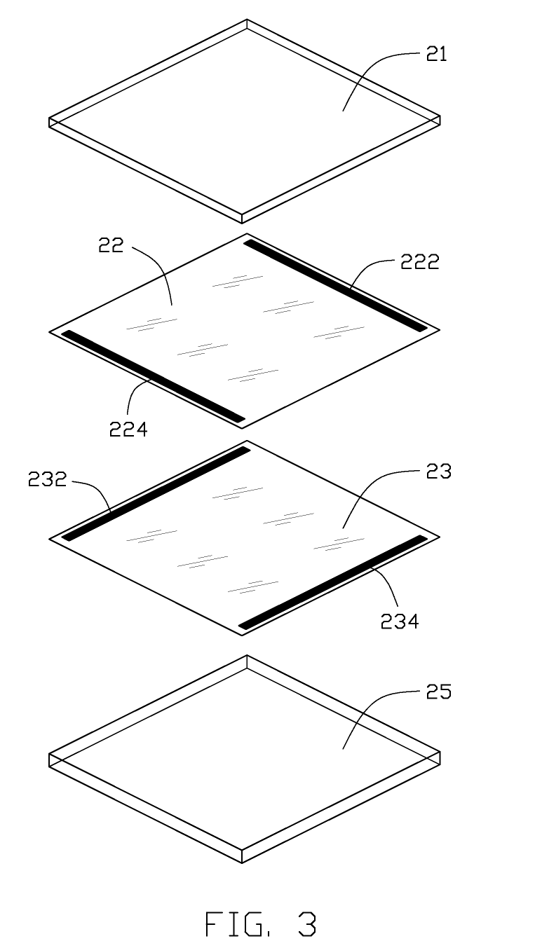

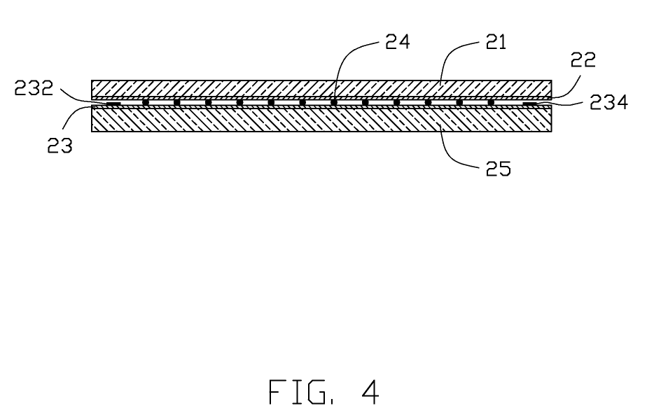

Referring to FIGS. 3-4, the side touch unit 20 includes a surface layer 21, a first conductive film 22, a second conductive film 23, a plurality of spacers 24, and a baseboard 25. The surface layer 21 may be thin insulating material with high light transitivity, such as glass, polycarbonate (PC), polyethylene terephthalate (PET), poly methyl methacrylate (PMMA), cyclic olefin copolymer, or other. In use, a surface of the surface layer 21 can be processed by a hard coat process to enhance surface hardness and avoid damage and wear.

The first conductive film 22 and the second conductive film 23 can be made from low-impedance transparent conductive material, such as indium tin oxide (ITO). The first conductive film 22 and the second conductive film 23 are respectively disposed on the relative surface of the surface layer 21 and the baseboard 25, and respectively configured as an X conductive layer and a Y conductive layer.

The first conductive film 22 includes two longitudinally spaced apart and parallel conductive electrodes 222 and 224. The conductive electrodes 222 and 224 are disposed on different sides of the first conductive film 22 and respectively configured for electrically connecting ends X− and X+. The second conductive film 23 includes two longitudinally spaced apart and parallel conductive electrodes 232 and 234. The conductive electrodes 232 and 234 are disposed on different sides of the second conductive film 23 and respectively configured for electrically connecting ends Y− and Y+, and be perpendicular to the electrodes 222 and 224.

The spacers 24 can be plastic or other insulating material, and are disposed between the first conductive film 22 and the second conductive film 23 to prevent contact therebetween. In practical use, thickness of the conductive films 22 and 23 and the size of the spacers 24 are relatively low, facilitating weight conservation and small size of the side touch unit 20.

The baseboard 25 can be transparent insulating material, such as transparent glass, acrylic sheet, PET sheet, etc. The baseboard 25 is configured for bearing and supporting the surface layer 21 and the conductive films 22 and 23 to wholly form a transparent touch panel.

The main touch unit 30, as an input and output interface, is configured for receiving and displaying various information and operating instructions. The main touch unit 30 is disposed on the front surface of the housing 10 and can be formed by an existing touch panel integrated with a liquid crystal display (LCD) or a cathode ray tube (CRT). The touch panel of the main touch unit 30 can use a resistive touch panel, which has the same operational principle as the side touch unit 20 as described. The 4-wire resistive touch panel is taken here as a preferred exemplary application. The main touch unit 30 also has four connecting ends X−, X+, Y−, and Y+ and can fulfill different operating requirements in two-dimensional direction.

In practical use, the side physical controls are often configured for adjusting volume, taking pictures, unlocking, browsing web pages and so on in one-dimensional orientation. Thus, the side touch unit 20 is configured for inputting or receiving different operating instructions in one-dimensional orientation. Therefore, in use, the connecting ends Y− and Y+ of the side touch unit 20 are respectively connected to the connecting ends Y− and Y+ of the main touch unit 30. The connecting end X+ of the side touch unit 20 is configured for outputting one-way detection voltage and the connecting end X− is in floating state to achieve different operations in a one-dimensional orientation.

The resistance compensation unit 40 uses an existing resistance compensation network and is electrically connected to the connecting ends Y− and Y+ of the side touch unit 20. The resistance compensation unit 40 is configured for compensating and increasing the resistance of the first conductive film 22 and the second conductive film 23, such that the side touch unit 20 can output a higher detection voltage to improve positioning accuracy of the side touch unit 20 when contacted.

The detection unit 50 can use an existing touch integrated circuit (IC), such as a TSC2007IYZGT chip. The detection unit 50 is electrically connected to the connecting ends X+, Y−, and Y+ of both the main touch unit 30 and the side touch unit 20, and electrically connected to the connecting end X− of the main touch unit 30. The detection unit 50 is configured for receiving the detection signal, such as a potential signal, from the side touch unit 20 and the main touch unit 30 to generate a corresponding command signal, such as coordinate data, according to different contact positions.

The processor 60 can be integrated with the central processing unit (CPU) of the portable electronic device with multiple touch panels 100, which prestores varieties of control procedures to control the side touch unit 20 and the main touch unit 30 when contacted. The processor 60 is configured for receiving the command signal from the detection unit 50 and generating a control signal, resulting in achieving varieties of touch operations, such as adjusting volume, taking pictures, browsing web pages, and others.

The portable electronic device with multiple touch panels 100 can use an existing lithium battery as a power supply, providing electric power for the operating system.

When the portable electronic device with multiple touch panels 100 with multiple touch keypads is in use, contact with the main touch unit 30 generates a corresponding detection signal. The detection unit 50 and the processor 60 process the detection signal to generate a corresponding control signal according to which the main touch unit 30 implements corresponding tasks, such as querying messages, finding phone numbers, and other primary controls. Contact with the side touch unit 20 results in a corresponding detection signal due to potential change of the side touch unit 20. The detection unit 50 receives the detection signal and generates a corresponding command signal to determine the touched position. The processor 60 receives the command signal from the detection unit 50 and generates a corresponding control signal based on the command signal, such that the side touch unit 20 implements various touch operations in one-dimensional orientation, such as adjusting volume, taking pictures, browsing web pages and other secondary controls. Thus, the side touch unit 20 can replace the varieties of physical controls to implement various operations, and the side touch unit 20 and the main touch unit 30 share the detection unit 50, making the portable electronic device with multiple touch panels 100 have multiple touch functions.

In the portable electronic device with multiple touch panels 100 of the exemplary embodiment, the side touch unit 20 and the main touch unit 30 share the detection unit 50, and the side touch unit 20 can fully replace varieties of physical controls to still input various information and operating instructions. Thereby, the portable electronic device with multiple touch panels 100 can eliminate the side physical buttons, with attendant conservation of the size and weight of the portable electronic device with multiple touch panels 100.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A portable electronic device with multiple touch panels, comprising:
a side touch unit configured for receiving touch information and generating a corresponding detection signal;
a main touch unit configured for receiving and relaying touch information to generate a corresponding detection signal;
a detection unit electrically connected to the side touch unit and the main touch unit, the detection unit configured for receiving and processing the detection signal from the side touch unit or the main touch unit to generate a corresponding command signal; and
a processor electrically connected to the detection unit, wherein the processor receives and processes the command signal from the detection unit and generates a corresponding control signal to achieve different touch operations when the side touch unit or the main touch unit is operated.

2. The portable electronic device with multiple touch panels as claimed in claim 1, wherein the side touch unit is a resistive touch panel.

3. The portable electronic device with multiple touch panels as claimed in claim 2, wherein the main touch unit includes a touch panel, the touch panel is also a resistive touch panel.

4. The portable electronic device with multiple touch panels as claimed in claim 1, further including a resistance compensation unit electrically connected to the side touch unit, wherein the resistance compensation unit can compensate and increase the resistance of the side touch unit to improve detection voltage and positioning accuracy.

5. The portable electronic device with multiple touch panels as claimed in claim 4, further including a housing having an exterior on which the side touch unit and the main touch unit are disposed, and an interior in which the resistance compensation unit, the detection unit, and the processor are disposed.

6. The portable electronic device with multiple touch panels as claimed in claim 1, wherein the side touch unit can output one-way detection voltage to the detection unit, the detection unit processes the detection signal to generate a corresponding command signal, and the processor processes the command signal to control the side touch unit achieve various touch operations in one-dimensional orientation.

7. A portable electronic device with multiple touch panels, comprising:
a side touch unit for receiving touch information and generating a corresponding detection signal;
a main touch unit configured for receiving and relaying touch information to generate a corresponding detection signal;
a detection unit electrically connected to the side touch unit and the main touch unit, the detection unit configured for receiving and processing the detection signal from the side touch unit or the main touch unit to generate a corresponding command signal; and
a processor electrically connected to the detection unit, wherein the processor receives and processes the command signal from the detection unit and generates a corresponding control signal to achieve different touch operations when the side touch unit or the main touch unit is operated, and the side touch unit achieves various touch operations in one-dimensional orientation.

8. The portable electronic device with multiple touch panels as claimed in claim 7, wherein the side touch unit is a resistive touch panel.

9. The portable electronic device with multiple touch panels as claimed in claim 8, wherein the main touch unit includes a touch panel, the touch panel is also resistive touch panel.

10. The portable electronic device with multiple touch panels as claimed in claim 7, further including a resistance compensation unit electrically connected to the side touch unit, wherein the resistance compensation unit can compensate and increase the resistance of the side touch unit to improve detection voltage and positioning accuracy.

11. The portable electronic device with multiple touch panels as claimed in claim 10, further including a housing having an exterior on which the side touch unit and the main touch unit are disposed, and an interior in which the resistance compensation unit, the detection unit, and the processor are disposed.

12. The portable electronic device with multiple touch panels as claimed in claim 7, wherein the side touch unit can output one-way detection voltage to the detection unit, the detection unit processes the detection signal to generate a corresponding command signal, and the processor processes the command signal to control the side touch unit achieve various touch operations in one-dimensional orientation.
